(19) United States
(12) Patent Application Publication
(10) Pub. No.: US 2024/0360026 A1
(43) Pub. Date: Oct. 31, 2024

(54) LITHIUM ION CONDUCTOR AND ALL-SOLID-STATE BATTERY COMPRISING THE SAME

(71) Applicant: SAMSUNG ELECTRO-MECHANICS CO., LTD., Suwon-si, Gyeonggi-do (KR)

(72) Inventors: Dooyoung Youn, Suwon-si, Gyeonggi-do (KR); Myung Jin Jung, Suwon-si, Gyeonggi-do (KR); Jieun Wang, Suwon-si, Gyeonggi-do (KR); Jongmin Kim, Suwon-si, Gyeonggi-do (KR); Kyunglock Kim, Suwon-si, Gyeonggi-do (KR); Bonseok Koo, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/038,916

(22) PCT Filed: May 2, 2023
(86) PCT No.: PCT/KR2023/005979

§ 371 Date: May 25, 2023

(30) Foreign Application Priority Data
May 9, 2022 (KR) 10-2022-0056753
May 11, 2022 (KR) 10-2022-0057961
Dec. 9, 2022 (KR) 10-2022-0171533
Feb. 15, 2023 (KR) 10-2023-0019808

(51) Int. Cl. C03C 3/064; C03B 19/06; C03C 4/18; H01M 4/131; H01M 4/485; H01M 10/0562; H01M 50/437; H01M 50/46

(52) U.S. Cl. CPC C03C 3/064; C03C 4/18; H01M 4/131; H01M 4/485; H01M 10/0562; H01M 50/437; H01M 50/46; C03B 19/06; C03C 2204/00; H01M 2300/0071

(57) ABSTRACT

A lithium ion conductor for an all-solid-state battery according to present disclosure includes an oxide including lithium (Li), silicon (Si), and boron (B) and has a crystallinity of less than or equal to 25.5%.

### TECHNICAL FIELD

The present disclosure relates to a lithium ion conductor and an all-solid-state battery including the same.

### BACKGROUND ART

Recently, as portable electronic devices are required to be down-sized and used for a long term, high-capacity batteries are required, and safety of the batteries is also required due to the spread of wearable electronic devices. Accordingly, development of an all-solid-state battery using a solid electrolyte instead of a liquid electrolyte is actively progressing.

Since the all-solid-state battery does not use a flammable organic solvent, additional circuitry for safety may be simplified. Therefore, the all-solid-state battery is expected as a technology capable of manufacturing a safe battery with high capacity per unit volume.

In addition, an oxide all-solid-state battery using an oxide electrolyte with lower ion conductivity (10⁴ S/cm to 10⁶ S/cm) than a sulfide electrolyte (10² S/cm) requires a high-temperature sintering process but exhibits excellent stability, compared with a sulfide all-solid-state battery using the sulfide electrolyte which reacts with oxygen and moisture in the air.

A stacked oxide all-solid-state battery is a micro-sized battery and thus may be mounted on a substrate like a passive device, and in addition, is stable even though exposed at a high temperature in a reflow process for this.

### DISCLOSURE OF INVENTION

### Technical Problem

One aspect of the embodiment provides a lithium ion conductor capable of freely adjusting ionic conductivity, minimizing an amount of decrease in ion conductivity in the process of manufacturing a stacked all-solid-state battery, and thus predicting ion conductivity in a stacked all-solid-state battery.

Another aspect of the embodiment provides a method for preparing the lithium ion conductor.

Another aspect of the embodiment provides an all-solid-state battery including the lithium ion conductor.

However, the object to be achieved by the embodiments is not limited to the abovementioned object but may be variously expanded without departing from the technical spirit of the embodiments.

### Solution to Problem

The lithium ion conductor according to an embodiment includes an oxide including lithium (Li), silicon (Si), and boron (B), and has a crystallinity less than or equal to 25.5%.

The crystallinity may be calculated by Equation 1:

$$Crystallinity ( \% ) = [ Ic / ( Ic + Ia ) ] \times 100. \qquad [ Equation 1 ]$$

In Equation 1, Ic is a sum of integrated values of scattering intensities of crystalline peaks in an X-ray diffraction analysis spectrum of the lithium ion conductor, and Ia is a sum of integral values of scattering intensities of an amorphous halo in the X-ray diffraction analysis spectrum of the lithium ion conductor.

The lithium ion conductor may have the crystallinity of 0% to 12.5%.

The lithium ion conductor may have a porosity of less than or equal to 1%.

The lithium ion conductor may have the porosity of 0% to 0.5%.

The lithium ion conductor may include 45 mol % to 80 mol % of lithium (Li) oxide, 5 mol % to 20 mol % of silicon (Si) oxide, and 15 mol % to 50 mol % of boron (B) oxide, based on a total amount of the lithium (Li) oxide, the silicon (Si) oxide, and the boron (B) oxide included in the lithium ion conductor.

The lithium ion conductor may include 50 mol % to 70 mol % of lithium (Li) oxide based on the total amount of the lithium (Li) oxide, the silicon (Si) oxide, and the boron (B) oxide included in the lithium ion conductor.

The lithium ion conductor may further include an additional oxide including Na (sodium), Mg (magnesium), Al (aluminum), P (phosphorus), K (potassium), Ca (calcium), Ti (titanium), V (vanadium), Cr (chromium), Mn (manganese), Fe (iron), Co (cobalt), Ni (nickel), Cu (copper), Zn (zinc), Ga (gallium), Ge (germanium), Se (selenium), Rb (rubidium), S (sulfur), Y (yttrium), Zr (zirconium), Nb (niobium), Mo (molybdenum), Ag (silver), In (indium), Sn (tin), Sb (antimony), Cs (cesium), Ba (barium), Hf (hafnium), Ta (tantalum), W (tungsten), Pb (lead), Bi (bismuth), Au (gold), La (lanthanum), Nd (neodymium), Eu (europium), or a combination thereof.

The lithium ion conductor may further include additional oxides including P (phosphorus) and Ge (germanium).

The lithium ion conductor may include an additional oxide in an amount of less than or equal to 5 mol % based on a total amount of the lithium (Li) oxide, the silicon (Si) oxide, the boron (B) oxide, and the additional oxide included in the lithium ion conductor.

The lithium ion conductor may include the additional oxide in the amount of less than or equal to 1 mol % based on the total amount of the lithium (Li) oxide, the silicon (Si) oxide, the boron (B) oxide, and the additional oxide included in the lithium ion conductor.

A method for preparing a lithium ion conductor according to another embodiment includes firing oxide powders including lithium (Li), silicon (Si), and boron (B) while pressurizing, and the lithium ion conductor has a crystallinity calculated by Equation 1 calculated by Equation 1 of less than or equal to 25.5%.

$$Crystallinity ( \% ) = [ Ic / ( Ic + Ia ) ] \times 100. \qquad [ Equation 1 ]$$

In Equation 1, Ic is a sum of integrated values of scattering intensities of crystalline peaks in an X-ray diffraction analysis spectrum of the lithium ion conductor, and Ia is a sum of integral values of scattering intensities of an amorphous halo in the X-ray diffraction analysis spectrum of the lithium ion conductor.

The firing may be performed at a temperature of 300° C. to 550° C.

During the pressurizing, a pressure of 1 MPa to 200 MPa may be applied.

An all-solid-state battery according to another embodiment includes a solid electrolyte layer and a positive electrode and a negative electrode disposed with the solid electrolyte layer therebetween. One selected from the solid electrolyte layer, the positive electrode, the negative electrode, and a combination thereof includes a lithium ion conductor including an oxide including lithium (Li), silicon (Si) and boron (B), and the lithium ion conductor has a crystallinity calculated by Equation 1 of less than or equal to 25.5%.

$$Crystallinity ( \% ) = [ Ic / ( Ic + Ia ) ] \times 100 \qquad [ Equation 1 ]$$

In Equation 1, Ic is a sum of integrated values of scattering intensities of crystalline peaks in an X-ray diffraction analysis spectrum of the lithium ion conductor, and Ia is a sum of integral values of scattering intensities of an amorphous halo in the X-ray diffraction analysis spectrum of the lithium ion conductor.

The lithium ion conductor may have a porosity of less than or equal to 1%.

The lithium ion conductor may include 45 mol % to 80 mol % of lithium (Li) oxide, 5 mol % to 20 mol % of silicon (Si) oxide, and 15 mol % to 50 mol % of boron (B) oxide, based on a total amount of the lithium (Li) oxide, the silicon (Si) oxide, and the boron (B) oxide included in the lithium ion conductor.

The lithium ion conductor may further include an additional oxide including Na (sodium), Mg (magnesium), Al (aluminum), P (phosphorus), K (potassium), Ca (calcium), Ti (titanium), V (vanadium), Cr (chromium), Mn (manganese), Fe (iron), Co (cobalt), Ni (nickel), Cu (copper), Zn (zinc), Ga (gallium), Ge (germanium), Sc (selenium), Rb (rubidium), S (sulfur), Y (yttrium), Zr (zirconium), Nb (niobium), Mo (molybdenum), Ag (silver), In (indium), Sn (tin), Sb (antimony), Cs (cesium), Ba (barium), Hf (hafnium), Ta (tantalum), W (tungsten), Pb (lead), Bi (bismuth), Au (gold), La (lanthanum), Nd (neodymium), Eu (europium), or a combination thereof.

An all-solid-state battery according to another embodiment includes a stack including a plurality of solid electrolyte layers and a plurality of positive electrodes and negative electrodes alternately disposed with the plurality of solid electrolyte layers therebetween, and first and second external electrodes on one side and the other side opposite to the one side of the stack and connected to the positive electrode and the negative electrode, respectively. One selected from the solid electrolyte layer, the positive electrode, the negative electrode, and a combination thereof includes a lithium ion conductor including an oxide including lithium (Li), silicon (Si) and boron (B), and the lithium ion conductor has a crystallinity calculated by Equation 1 of less than or equal to 25.5%.

$$Crystallinity ( \% ) = [ Ic / ( Ic + Ia ) ] \times 100 \qquad [ Equation 1 ]$$

In Equation 1, Ic is a sum of integrated values of scattering intensities of crystalline peaks in an X-ray diffraction analysis spectrum of the lithium ion conductor, and Ia is a sum of integral values of scattering intensities of an amorphous halo in the X-ray diffraction analysis spectrum of the lithium ion conductor.

The lithium ion conductor may have a porosity of less than or equal to 1%.

The lithium ion conductor may include 45 mol % to 80 mol % of lithium (Li) oxide, 5 mol % to 20 mol % of silicon (Si) oxide, and 15 mol % to 50 mol % of boron (B) oxide, based on a total amount of the lithium (Li) oxide, the silicon (Si) oxide, and the boron (B) oxide included in the lithium ion conductor.

The lithium ion conductor may further include an additional oxide including Na (sodium), Mg (magnesium), Al (aluminum), P (phosphorus), K (potassium), Ca (calcium), Ti (titanium), V (vanadium), Cr (chromium), Mn (manganese), Fe (iron), Co (cobalt), Ni (nickel), Cu (copper), Zn (zinc), Ga (gallium), Ge (germanium), Se (selenium), Rb (rubidium), S (sulfur), Y (yttrium), Zr (zirconium), Nb (niobium), Mo (molybdenum), Ag (silver), In (indium), Sn (tin), Sb (antimony), Cs (cesium), Ba (barium), Hf (hafnium), Ta (tantalum), W (tungsten), Pb (lead), Bi (bismuth), Au (gold), La (lanthanum), Nd (neodymium), Eu (europium), or a combination thereof.

### Advantageous Effects of Invention

The lithium ion conductor according to the embodiment is capable of freely adjusting ionic conductivity, minimizing an amount of decrease in ion conductivity in the process of manufacturing a stacked all-solid-state battery, and thus predicting ion conductivity in a stacked all-solid-state battery.

### BRIEF DESCRIPTION OF DRAWINGS

FIG. 1 is a perspective view schematically illustrating an all-solid-state battery according to an embodiment.

FIG. 2 is a cross-sectional view of an all-solid-state battery according to the embodiment shown in FIG. 1.

FIG. 3 is an exploded perspective view schematically illustrating a unit cell stack structure of an all-solid-state battery according to the embodiment shown in FIG. 1.

FIG. 4 is an ion milling cross-section scanning electron microscope (SEM) photograph of a Li₂O—B₂O₃—SiO₂ amorphous lithium ion conductor cullet.

FIG. 5 is an ion milling cross-section scanning electron microscope (SEM) photograph of a lithium ion conductor pellet according to Example 1.

FIG. 6 is an ion milling cross-section scanning electron microscope (SEM) photograph of a lithium ion conductor pellet according to Comparative Example 1.

FIG. 7 is an ion milling cross-section scanning electron microscope (SEM) photograph of a lithium ion conductor pellet according to Comparative Example 3.

FIG. 8 is an ion milling cross-section scanning electron microscope (SEM) photograph of a lithium ion conductor pellet according to Comparative Example 4.

FIG. 9 shows thermal behavior results of a cullet and a frit having 50 mol % of Li₂O through an DSC analysis.

FIG. 10 shows results of analyzing each crystal state of a cullet, a frit, and a lithium ion conductor through an XRD analysis.

FIG. 11 shows SEM-EDAX mapping analysis results of the lithium ion conductors.

FIG. 12 shows cole-cole plot results of the lithium ion conductors according to Example 1 and Comparative Example 1.

FIG. 13 is a voltage-capacity graph in symmetric cells of the lithium ion conductors according to Example 1 and Comparative Example 1.

### MODE FOR THE INVENTION

Hereinafter, various embodiments of the present invention will be described in detail with reference to the accompanying drawings so that those skilled in the art may easily carry out the present invention. The drawings and description are to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present invention includes all modifications, equivalents, and substitutions without departing from the scope and spirit of the present invention. In addition, some constituent elements in the accompanying drawings are exaggerated, omitted, or schematically illustrated, and the size of each constituent element does not entirely reflect the actual size.

In addition, unless explicitly described to the contrary, the word “comprise,” and variations such as “comprises” or “comprising,” will be understood to imply the inclusion of stated elements but not the exclusion of any other elements.

Through the specification, the “stacking direction” refers to a direction in which constituent elements are sequentially stacked or the “thickness direction” perpendicular to the large surface (main surface) of the sheet-shaped constituent elements, which corresponds to a T-axis direction in the drawing. In addition, the “side direction” refers to a direction extending parallel to the large surface (main surface) from the edge of the sheet-shaped constituent elements or a “planar direction,” which corresponds to an L-axis direction in the drawing.

Hereinafter, various embodiments and modifications will be described in detail with reference to the drawings.

A lithium ion conductor according to an embodiment includes an oxide including lithium (Li), silicon (Si), and boron (B). The lithium ion conductor may be used as a battery material such as an all-solid-state battery, for example, a solid electrolyte, an electrode binder, or a coating material.

For example, the lithium ion conductor may include lithium (Li) oxide (Li₂O), silicon (Si) oxide (SiO₂), and boron (B) oxide (B₂O₃).

The lithium ion conductor may include 45 mol % to 80 mol % of lithium (Li) oxide, 5 mol % to 20 mol % of silicon (Si) oxide, and 15 mol % to 50 mol % of boron (B) oxide, based on the total amount of the lithium ion conductor, or may include for example 50 mol % to 70 mol % of lithium (Li) oxide, 5 mol % to 15 mol % of silicon (Si) oxide, and 35 mol % to 45 mol % of boron (B) oxide, based on the total amount of the lithium ion conductor. When the content of lithium (Li) oxide is 45 mol % or less, lithium ion conductivity may be low, and when the content of lithium (Li) oxide is greater than 80 mol %, devitrification of glass may occur. When the silicon (Si) oxide is less than 5 mol %, the obtained lithium ion conductor may be vulnerable, when exposed to a high humidity environment, and when the silicon (Si) oxide is greater than 20 mol %, the ion conductivity may be lowered, and the devitrification may occur. When the boron (B) oxide is less than 15 mol %, the ion conductivity may be lowered, and the devitrification may occur, and when the boron (B) oxide is greater than 50 mol %, the obtained lithium ion conductor may be vulnerable when exposed to the high humidity environment.

Optionally, the lithium ion conductor may further include an additional oxide. For example, the additional oxide may further include an additional oxide including Na (sodium), Mg (magnesium), Al (aluminum), P (phosphorus), K (potassium), Ca (calcium), Ti (titanium), V (vanadium), Cr (chromium), Mn (manganese), Fe (iron), Co (cobalt), Ni (nickel), Cu (copper), Zn (zinc), Ga (gallium), Ge (germanium), Sc (selenium), Rb (rubidium), S (sulfur), Y (yttrium), Zr (zirconium), Nb (niobium), Mo (molybdenum), Ag (silver), In (indium), Sn (tin), Sb (antimony), Cs (cesium), Ba (barium), Hf (hafnium), Ta (tantalum), W (tungsten), Pb (lead), Bi (bismuth), Au (gold), La (lanthanum), Nd (neodymium), Eu (europium), or a combination thereof, and for example the lithium ion conductor may further include an additional oxide including P (phosphorus) and Ge (germanium).

The lithium ion conductor may include an additional oxide in an amount of less than or equal to 5 mol %, or for example less than or equal to 1 mol % based on the total amount of the lithium ion conductor. When the content of the additional oxide is greater than 5 mol %, the devitrification may occur during the preparation of glass, or the ion conductivity may be lowered due to secondary crystal phases generated during the sintering.

The lithium ion conductor may have a crystallinity calculated by Equation 1 of less than or equal to 25.5%, for example, 0% to 12.5%, or 0% to 5%.

$$Crystallinity ( \% ) = [ Ic / ( Ic + Ia ) ] \times 100 \qquad [ Equation 1 ]$$

In Equation 1, Ic is a sum of integrated values of scattering intensities of crystalline peaks in the X-ray diffraction analysis spectrum of the lithium ion conductor, and Ia is a sum of integral values of the scattering intensities of the amorphous halo in the X-ray diffraction analysis spectrum of the lithium ion conductor.

For example, the lithium ion conductor may be calculated with respect to a degree of crystallinity based on a graph obtained through X-ray diffraction spectroscopy. In the X-ray diffraction analysis spectrum, an X ray wavelength λ with an incident angle θ and a lattice interplanar spacing d has a relationship of 2d·sin θ=nλ, which is called to be Bragg equation. Accordingly, when the incident angle is determined, the lattice spacing d may be obtained. However, since random atomic alignments rather than regular atomic alignments appear in an amorphous material, a plurality of X-ray diffractions do not appear at a specific wavelength, but a wide halo pattern appears in a diffraction angle region of 15° to 35°. In a diffraction angle region of 10° to 60°, a peak at a specific angle but a diffuse halo pattern appears, which judges an amorphous material having crystallinity of 0%. However, the surface of the lithium ion conductor that are exposed to X-rays must not contain contaminants other than an organic material. Results, only when measured under conditions free from factors affecting diffraction patterns, may have high reliability. When crystals exist in the lithium ion conductors, one or more crystalline peaks exist in the corresponding measurement diffraction angle range. Herein, as crystallinity is higher, a halo region is reduced, and when the crystallinity is 100%, there is no halo region. When crystalline and amorphous are mixed, the crystallinity is obtained by calculating a relative ratio of an area of the halo region to that of the crystalline peak region in a graph of intensity and the diffraction angle range.

Crystallinity of a lithium ion conductor may be adjusted by changing a content of lithium (Li) oxide, for example, as the content of lithium (Li) oxide is increased, a crystallization temperature gradually overall decreases, thereby increasing the crystallinity. In this way, the crystallinity of the lithium ion conductor may be controlled to freely adjust ion conductivity.

When the crystallinity of the lithium ion conductor is greater than 25.5%, the ion conductivity may be allowed, and for example, when the crystallinity is greater than 50.0%, the ion conductivity may be lost, but insulator-like properties may appear.

The lithium ion conductor may have a porosity of less than or equal to 1%, or for example 0% to 0.5%.

The porosity of the lithium ion conductor may be measured by taking a scanning electron microscope (SEM) photograph. For example, after preparing a sample by etching the surface of the lithium ion conductor into a very smooth one, the scanning electron microscope photograph of the surface is taken. Since the surface etching of the lithium ion conductor may be performed by using a fine sandpaper, which may damage on the sample and distort its information, an ultra-precision etching apparatus such as plasma etching, reactive ion etching, or the like may be used. The scanning electron microscope photograph is taken at 30 K magnification or 50 K magnification so that pores of the lithium ion conductor may be seen, and the porosity may be measured, for example, in an image with a width of 40 μm×a length of 30 μm.

Herein, when the lithium ion conductor has pores, the pores appear dark in the scanning electron microscope photograph. An image program such as an electron beam microanalyzer (EPM A) and the like may be used to calculate a ratio of bright and dark regions, wherein the electron beam microanalycer (EPMA) may include EDS (energy dispersive spectrometer), WDS (wavelength dispersive spectrometer), or the like. Herein, the dark region is assumed to be pores, and the bright region is assumed to be the lithium ion conductor in contrast. For example, the porosity of the lithium ion conductor may be binarized by using the scanning electron microscope image with EDS, etc. and then, calculated with respect to an area ratio of a region with different contrast to a full view region for measurement. In addition, the measurement is performed at at least 3, 5, or 10 different points or on the cross-section, and measurement values obtained therefrom may be calculated into an arithmetic mean.

As the lithium ion conductor has porosity of 1% or less, density of the lithium ion conductor increases, which may minimize a decrease in the ion conductivity during the process of manufacturing a stacked all-solid-state battery, and accordingly, ion conductivity of the stacked all-solid-state battery may also be predicted.

When the porosity of the lithium ion conductor is greater than 1%, the lithium ion conductor may exhibit a drop in the ion conductivity or become vulnerable to an external environment. As the porosity is larger, the lithium ion conductor may exhibit a larger drop in the ion conductivity or become more vulnerable to the external environment.

A method of preparing a lithium ion conductor according to another embodiment includes firing oxide powders including lithium (Li), silicon (Si), and boron (B) while pressurizing it.

First, several types of amorphous materials are mixed as raw materials.

The amorphous material may include a network forming oxide (network former: NWF), a modifying oxide (network modifier), and, if necessary, an intermediate oxide may be used.

The network forming oxide itself may be vitrified. The modifying oxide may not be amorphous itself but amorphized in a network structure formed by the network shaped oxide, that is, modify the network.

The network forming oxide may include SiO₂ and B₂O₃. The modifying oxide may include Li₂O.

The intermediate oxide is a raw material having intermediate properties between the network forming oxide and the modifying oxide and, for example, has an effect of lowering a thermal expansion coefficient among thermal properties of glass.

Examples of the intermediate oxide may include an oxide including Na (sodium). Mg (magnesium), Al (aluminum), P (phosphorus), K (potassium), Ca (calcium), Ti (titanium), V (vanadium), and Cr (chromium)), Mn (manganese), Fe (iron), Co (cobalt), Ni (nickel), Cu (copper), Zn (zinc), Ga (gallium), Ge (germanium), Se (selenium), Rb (rubidium)), S (sulfur), Y (yttrium), Zr (zirconium), Nb (niobium), Mo (molybdenum), Ag (silver), In (indium), Sn (tin), Sb (antimony), Cs (cesium)), Ba (barium), Hf (hafnium), Ta (tantalum), W (tungsten), Pb (lead), Bi (bismuth), Au (gold), La (lanthanum), Nd (neodymium), Eu (europium)), or a combination thereof.

Li₂O may be included in an amount of 45 mol % to 80 mol % or 50 mol % to 70 mol % based on a total amount of Li₂O, SiO₂, and B₂O₃, SiO₂ may be included in an amount of 5 mol % to 20 mol % based on the total amount of Li₂O, SiO₂, and B₂O₃, B₂O₃ may be included in an amount of 15 mol % to 50 mol % based on the total amount of Li₂O, SiO₂, and B₂O₃.

When the intermediate oxide is used as an amorphous material, the intermediate oxide may be used in an amount of 5 mol % or less based on a total amount of the network forming oxide, the modifying oxide, and the intermediate oxide.

A precursor (glass) of the lithium ion conductor may be prepared by vitrifying the raw material. A method of vitrifying the raw material may include, for example, a method of melting the raw material to a molten liquid and allowing it to cool, a method of pressing the molten liquid into a metal plate and the like, a method of dropping it into mercury, a method of using strip furnace, a splat rapid cooling method, a rolling (single, twin) method and in addition, a mechanical milling method, a sol-gel method, a deposition method, a sputtering method, a laser ablation method, a PLD (pulse laser disposition) method, a plasma method, or the like.

The lithium ion conductor may be prepared by firing the precursor of the lithium ion conductor while pressurizing it. At this time, the firing may be performed at a temperature of 300° C. to 550° C., for example, 400° C. to 500° C., and the pressurizing may be performed by applying a pressure of 1 MPa to 200 MPa, for example, 1 MPa to 50 MP.

The lithium ion conductor prepared by firing the precursor of the lithium ion conductor while pressurizing may have a crystallinity of less than or equal to 25.5% and a porosity of less than or equal to 1%.

Optionally, the prepared lithium ion conductor may be powdered. As a preparing method of powder, a mechanochemical method etc. are used.

An all-solid-state battery according to another embodiment includes a solid electrolyte layer and a positive electrode and a negative electrode disposed with the solid electrolyte layer therebetween, wherein any one selected from the solid electrolyte layer, the positive electrode, the negative electrode, and a combination thereof includes the lithium ion conductor according to an embodiment.

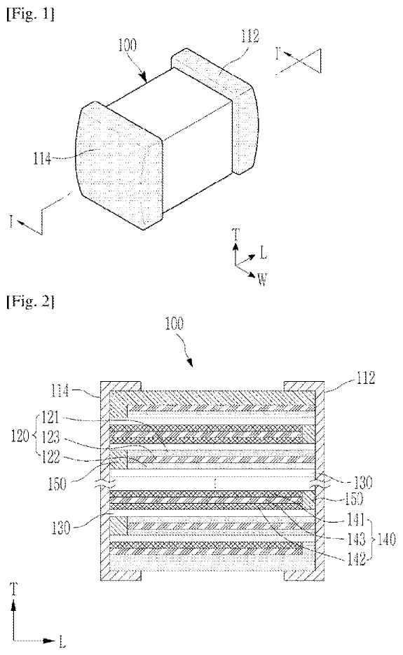

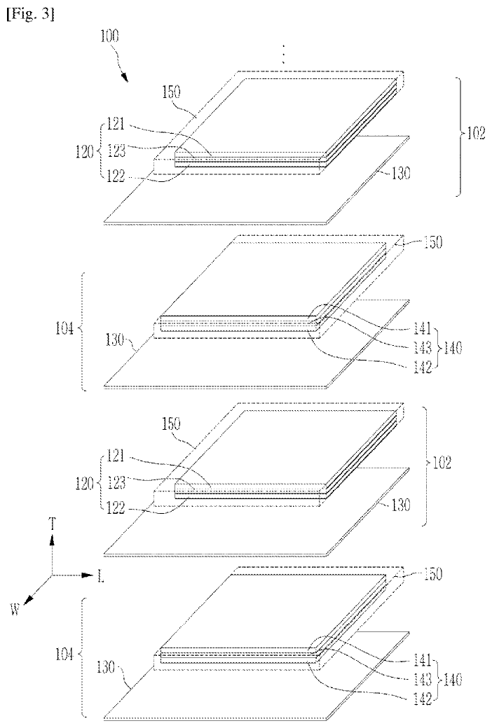

FIG. 1 is a perspective view schematically illustrating an all-solid-state battery according to another embodiment. FIG. 2 is a cross-sectional view of an all-solid-state battery according to the embodiment shown in FIG. 1, and FIG. 3 is an exploded perspective view schematically illustrating a unit cell stack structure of an all-solid-state battery according to the embodiment shown in FIG. 1. Hereinafter, an all-solid-state battery will be described in detail with reference to FIGS. 1 to 3.

The all-solid-state battery 100 may have, for example, an approximate hexahedral shape.

In the present example embodiment, for convenience of description, in the all-solid-state battery 100, both surfaces facing each other in a thickness direction (T-axis direction) are defined as first and second surfaces, and both surfaces connected to the first and second surfaces and facing each other in a length direction (L-axis direction) are defined as third and fourth surfaces. For example, the first and second surfaces of the all-solid-state battery 100 may be connected to the third and fourth surfaces.

The all-solid-state battery 100 according to the present embodiment includes electrode layers 120 and 140 and a solid electrolyte layer 130 adjacent to the electrode layers 120 and 140 in a stacking direction. The electrode layers 120 and 140 may include a positive electrode layer 120 and a negative electrode layer 140, and may basically include the current collectors 123 and 143 and the active material layers 121, 122, 141, and 142 coated on at least one surface of the current collectors 123 and 143.

The positive electrode layer 120 may be formed by coating the positive electrode active material layers 121 and 122 on at least one surface of the positive electrode current collector 123, and the negative electrode layer 140 may be formed by coating the negative electrode active material layers 141 and 142 on at least one surface of the negative electrode current collector 143. For example, the uppermost electrode layer in the stacking direction may be formed by coating the positive electrode active material layer 122 on one surface of the positive electrode current collector 123, and the lowermost electrode layer may be formed by coating the negative electrode active material layer 141 on one surface of the negative electrode current collector 143. In addition, the electrode layers between the uppermost and lowermost ends are formed by coating the positive electrode active material layers 121 and 122 on both surfaces of the positive electrode current collector 123, or by coating the negative electrode active material layers 141 and 142 on both surfaces of the negative electrode current collector 143.

The positive electrode active material layers 121 and 122 may include a positive electrode active material and, optionally, a solid electrolyte. In addition, the positive electrode active material layers 121 and 122 may optionally further include an additive such as a binder or a conductive agent.

For example, the positive electrode active material is not particularly limited as long as it can secure sufficient capacity of the all-solid-state battery 100. For example, the positive electrode active material may include lithium cobalt oxide, lithium nickel cobalt manganese oxide, lithium nickel cobalt aluminum oxide, lithium iron phosphate, lithium manganese oxide, or a combination thereof.

For example, the positive electrode active material may be compounds represented by the following chemical formulas: LiₐA_{1-b}M_{b}D₂ (wherein 0.90≤a≤1.8, 0≤b≤0.5); LiₐE_{1-b} M_{b}O_{2-c}D_{c} (wherein 0.90≤a≤1.8, 0≤b≤0.5, 0≤c≤0.05); LiE_{2-b}M_{b}O_{4-c}D_{c} (wherein 0≤b≤0.5, 0≤c≤0.05); LiₐNi_{1-b-c}Co_{b}M_{c}D_{α} (wherein 0.90≤a≤1.8, 0≤b≤0.5, 0≤c≤0.05, 0<α≤2); LiₐNi_{1-b-c}Co_{b}M_{c}O_{2-α}X_{α} (wherein 0.90≤a≤1.8, 0≤b≤0.5, 0≤c≤0.05, 0<α<2); Liₐ Ni_{1-b-c}CO_{b}M_{c}O_{2-α}X₂ (wherein 0.90≤a≤1.8, 0≤b≤0.5, 0≤c≤0.05, 0<α<2); LiₐNi_{1-b-c}Mn_{b}M_{c} D_{α} (wherein 0.90≤a≤1.8, 0≤b≤0.5, 0≤c≤0.05, 0<α≤2); LiₐNi_{1-b-c}Mn_{b}M_{c}O_{2-α}X_{α} (wherein 0.90≤a≤1.8, 0≤b≤0.5, 0≤c≤0.05, 0<α<2); LiₐNi_{1-b-c}Mn_{b}M_{c}O_{2-α}X₂ (wherein 0.90≤a≤1.8, 0≤b≤0.5, 0≤c≤0.05, 0<α<2); LiₐNi_{b}E_{c}G_{d}O₂ (wherein 0.90≤a≤1.8, 0≤b≤0.9, 0≤c≤0.5, 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, 0.001≤e≤0.1); LiₐNiG_{b}O₂ (wherein 0.90≤a≤1.8, 0.001≤b≤0.1); Liₐ CoG_{b}O₂ (wherein 0.90≤a≤1.8, 0.001≤b≤0.1); LiₐMnG_{b}O₂ (wherein 0.90≤a≤1.8, 0.001≤b≤0.1); LiₐMn₂G_{b}O₄ (wherein 0.90≤a≤1.8, 0.001≤b≤0.1); QO₂; QS₂; LiQS₂; V₂O₅; LiV₂O₂; LiRO₂; LiNiVO₄; Li_{(3-f)}J₂(PO₄)₃ (0≤f≤2); Li_{(3-f)}Fe₂(PO₄)₃ (wherein 0≤s≤2); and LiFePO₄, wherein in the above chemical formulas, A is Ni, Co, or Mn; M is Al. Ni, Co, Mn, Cr, Fe, Mg, Sr, V, or a rare-earth element; D is O, F, S, or P; E is Co or Mn; X is F, S, or P; G is Al, Cr, Mn, Fe, Mg, La, Ce, Sr, or V; Q is Ti, Mo, or Mn; R is Cr, V, Fe, Sc, or Y; and J is V, Cr, Mn, Co, Ni, or Cu.

The positive electrode active material may also be LiCoO₂, LiMnₓO₂, (wherein x=1 or 2), LiNi₁₋ₓMnₓO₂ₓ (wherein 0<x<1), LiNi_{1-x-y}CoₓMn_{y}O₂ (wherein 0≤x≤0.5 and 0≤y≤0.5), LiFePO₄, TiS₂, FeS₂, TiS₃, or FeS₃.

The solid electrolyte may include a lithium ion conductor according to an embodiment. A content of the solid electrolyte may be greater than or equal to 0.1 parts by weight, greater than or equal to 1 part by weight, or greater than or equal to 10 parts by weight, and less than or equal to 80 parts by weight, less than or equal to 60 parts by weight, or less than or equal to 50 parts by weight, based on 100 parts by weight of the total amount of the positive electrode active material.

The conductive agent is not particularly limited as long as it has conductivity without causing chemical change in the all-solid-state battery 100. For example, examples of the conductive agent may include: graphite such as natural graphite and artificial graphite; carbon-based substances such as carbon black, acetylene black, ketjen black, channel black, furnace black, lamp black, and summer black; conductive fibers such as carbon fibers and metal fibers; fluorinated carbon; metal powders such as aluminum and nickel powder; conductive whiskers such as zinc oxide and potassium titanate; conductive metal oxides such as titanium oxide; or conductive materials such as polyphenylene derivatives.

A content of the conductive agent may be 1 part by weight to 10 parts by weight, for example, 2 parts by weight to 5 parts by weight, based on 100 parts by weight of the positive electrode active material. When the content of the conductive agent is within the above range, a finally obtained electrode may have excellent conductivity characteristics.

The binder may be used to improve bonding strength between an active material and a conductive agent. The binder may include polyvinylidene fluoride, polyvinyl alcohol, carboxymethyl cellulose (CMC) starch, hydroxypropyl cellulose, regenerated cellulose, polyvinylpyrrolidone, polytetrafluoroethylene, polyethylene, polypropylene, an ethylene-propylene-diene terpolymer (EPDM), sulfonated EPDM, a styrene butadiene rubber, a fluororubber, or various copolymers, and the like.

A content of the binder may be 1 part by weight to 50 parts by weight, for example, 2 parts by weight to 5 parts by weight, based on 100 parts by weight of the total positive electrode active material. When the content of the binder satisfies the above range, the active material layer may have high bonding strength.

As the positive electrode current collector 123, a porous material such as a mesh or mesh shape may be used, and a porous metal plate such as stainless steel, nickel, or aluminum may be used. In addition, the positive electrode current collector 123 may be coated with an oxidation-resistant metal or alloy film to prevent oxidation.

The negative electrode active material layers 141 and 142 may include a negative electrode active material and, optionally, a solid electrolyte. In addition, the negative electrode active material layers 141 and 142 may optionally further include an additive such as a binder or a conductive agent.

The negative electrode active material may be a carbon-based material, silicon, a silicon oxide, a silicon-based alloy, a silicon-carbon-based material composite, tin, a tin-based alloy, a tin-carbon composite, a metal oxide, or a combination thereof, and may include a lithium metal and/or a lithium metal alloy.

The lithium metal alloy may include lithium and a metal/semi-metal capable of alloying with lithium. For example, the metal/semi-metal capable of alloying with lithium may include Si, Sn, Al, Ge, Pb, Bi, Sb, a Si—Y alloy (wherein Y is an alkali metal, an alkaline-earth metal, Group 13 to Group 16 elements, a transition metal, a rare earth element, or a combination thereof, and Si is not included), a Sn—Y alloy (wherein Y is an alkali metal, an alkaline earth metal, Group 13 to Group 16 elements, a transition metal, or a transition metal oxide such as lithium titanium oxide (Li₄Ti₅O₁₂), a rare earth element, or a combination thereof, and Sn is not included), or MO, (0<x≤2).

The element Y may be Mg, Ca, Sr, Ba, Ra, Sc, Y, Ti, Zr, Hf, Rf, V, Nb, Ta, Dh, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

In addition, the oxide of a metal/semi-metal capable of alloying with lithium may be lithium titanium oxide, vanadium oxide, lithium vanadium oxide, SnO₂, SiOₓ (0<x<2), and the like. For example, the negative electrode active material may include one or more elements selected from elements of Groups 13 to 16 of the periodic table of elements. For example, the negative electrode active material may include one or more elements selected from the group consisting of Si, Ge, and Sn.

The carbon-based material may be crystalline carbon, amorphous carbon, or mixtures thereof. The crystalline carbon may include graphite, such as natural graphite or artificial graphite in irregular, plate, flake, spherical, or fibrous form. In addition, the amorphous carbon may include soft carbon (low temperature calcined carbon) or hard carbon, a mesophase pitch carbonization product, calcined coke, graphene, carbon black, fullerene soot, carbon nanotubes, carbon liber, and the like.

The silicon may be Si, SiOₓ 0<x<2, for example 0.5 to 1.5), Sn, SnO₂, a silicon-containing metal alloy, or a mixture thereof. The silicon-containing metal alloy may include, for example, silicon and one or more of Al, Sn, Ag, Fc, Bi, Mg, Zn, In, Ge, Pb, and Ti.

The solid electrolyte may include the lithium ion conductor according to an embodiment. A content of the solid electrolyte may be greater than or equal to 0.1 parts by weight, greater than or equal to 1 part by weight, or less than or equal to 10 parts by weight, less than or equal to 80 parts by weight, less than or equal to 60 part by weight, or less than or equal to 50 parts by weight based on 100 parts by weight of the total amount of the negative electrode active material.

The negative electrode active material layer may also optionally include a conductive agent and a binder as described in the positive electrode active material layer.

The negative electrode current collector 143 may be a mesh or mesh-shaped porous body, and a porous metal plate such as stainless steel, nickel, or aluminum. In addition, the negative electrode current collector 143 may be coated with an oxidation-resistant metal or alloy film to prevent oxidation.

The solid electrolyte layer 130 may be interposed and stacked between the positive electrode layer 120 and the negative electrode layer 140. Therefore, the solid electrolyte layer 130 may be adjacently disposed between the positive electrode active material layers 121 and 122 of the positive electrode layer 120 and the negative electrode active material layers 141 and 142 of the negative electrode layer 140 in the stacking direction. Therefore, in the all-solid-state battery 100, a plurality of positive electrode layers 120 and a plurality of negative electrode layers 140 may be alternately disposed, and a plurality of solid electrolyte layers 130 may be interposed and stacked therebetween. The all-solid-state battery 100 is a stacked all-solid-state battery 100 manufactured by alternately stacking a plurality of positive electrode layers 120 and negative electrode layers 140, and interposing a plurality of solid electrolyte layers 130 therebetween to provide a cell stack, and then firing them collectively.

The solid electrolyte layer 130 may include an inorganic solid electrolyte including an oxide-based solid electrolyte, a sulfide-based solid electrolyte, or a combination thereof. For example, the solid electrolyte layer 130 may include the lithium ion conductor according to an embodiment.

The oxide-based solid electrolyte may be a garnet-type, NASICON-type, LISICON-type, perovskite-type, LiPON-type, or amorphous (glass) electrolyte.

The garnet-based solid electrolyte may include lithium-lanthanum zirconium oxide (LLZO) represented by LiₐLa_{b}Zr_{c}O₁₂ such as Li₇La₃Zr₂O₁₂, and the NASICON-based solid electrolyte may include a lithium-aluminum-titanium-phosphate salt (LATP) of Li₁₊ₓAlₓTi₂₋ₓ (PO₄)₃ (0<x<1) in which Ti is introduced into a Li₁₊ₓAlₓM₂₋ₓ(PO₄)₃ (LAMP) (0<x<2, M is Zr, Ti, or Ge) type compound, lithium-aluminum-germanium-phosphate (LAGP) represented by Li₃₊ₓAlₓGe₂₋ₓ(PO₄)₃ (0<x<1) such as Li_{1.3}Al_{0.3}Ti_{1.7}(PO₄)₃ introduced with excess lithium and/or lithium-zirconium-phosphate (LZP) of LiZr₂(PO₄)₃

In addition, the LISICON-based solid electrolyte may include a solid solution oxide represented by xLi₃AO₄-(1−x)Li₄BO₄ (wherein A is P, As, or V and B is Si, Ge, or Ti) such as Li₄Zn(GeO₄)₄, Li₁₀GeP₂O₁₂(LGPO), Li_{3.5}Si_{0.5}P_{0.5}O₄, or Li_{10.42}Si(Ge)_{1.5}P_{1.5}Cl_{0.08}O_{11.92}, or a solid solution sulfide represented by Li₄₋ₓM_{1-y}M′_{y}S₄, (wherein M is Si, or Ge and M′ is P, Al, Zn, or Ga) such as Li₂S—P₂S₅, Li₂S—SiS₂, Li₂S—SiS₂—P₂S₅, or Li₂S—GeS₂.

The perovskile-based solid electrolyte may include lithium lanthanum titanate (LLTO) represented by Li₃ₓLa_{2/3-x}□_{1/3-2x}TiO₃ (0<x<0.16, □: vacancy) such as Li_{1/8}La_{5/8} TiO₃. The LiPON-bused solid electrolyte may include a lithium phosphorous oxynitride such as Li_{2.8}PO_{3.3}N_{0.46}.

Examples of the amorphous electrolyte include Li₂O—B₂O₃—SiO₂, Li₂O—B₂O—P₂O₅, Li₃BO₃—Li₂SO₄, or Li₃BO₃—Li₂CO₃.

The sulfide-based solid electrolyte may include a sulfur atom among electrolyte components and is not limited to a specific component, and may include one or more of a crystalline solid electrolyte, an amorphous solid electrolyte (glassy solid electrolyte), or a glass ceramic solid electrolyte.

For example, the sulfide-based solid electrolyte may include an LPS-type sulfide containing sulfur and phosphorus (e.g., Li₂S—P₂S₅), for example a thio-LISICON-based compound such as Li₄₋ₓGe₁₋ₓPₓS₄ (x is 0.1 to 2, or x is 3/4, or 2/3), Li_{10±1}MP₂X₁₂ (M is Ge, Si, Sn, or Al and X is S, or Se), Li_{3.833}Sn_{0.833}As_{0.166}S₄, Li₄SnS₄, Li_{3.25}Ge_{0.25}P_{0.75}S₄, Li₂S—P₂S₅, B₂S₃—Li₂S, xLi₂S-100-xP₂S₅ (x is 70 to 80), Li₂S—SiS₂—Li₃N, Li₂S—P₂S₅—LiI, Li₂S—SiS₂—LiI, Li₂S—B₂S₃—LiI, Li₁₀SnP₂S₁₂, Li_{3.25}P_{0.75}S₄.

The ionic conductivity of the solid electrolyte may be greater than or equal to 1×10⁴ S/cm. The ionic conductivity may be measured at a temperature of 25° C. The ion conductivity may be greater than or equal to 1×10⁻⁶ S/cm, greater than or equal to 2×10⁻⁶ S/cm, greater than or equal to 3×10⁻⁶ S/cm, greater than or equal to 4×10⁻⁶ S/cm, greater than or equal to 5×10⁻⁶ S/cm, or greater than or equal to 1×10⁻³ S/cm, of which an upper limit is not particularly limited. When a solid electrolyte satisfying the ranges of ionic conductivity is used, the all-solid-state baltery 100 may exhibit high output.

The margin insulation layer 150 may be disposed along edges of the positive electrode layer 120 and the negative electrode layer 140. The margin insulation layer 150 may be disposed on the solid electrolyte layer 130 and may be formed laterally adjacent to edges of the positive electrode active material layers 121 and 122 or the negative electrode active material layers 141 and 142. Accordingly, the margin insulation layer 150 may be disposed on the same layer as the positive electrode layer 120 and the negative electrode layer 140.

The margin insulation layer 150 may include an insulating material having an ionic conductivity of less than or equal to 1=10⁻¹⁰ S/cm or less than or equal to 1.0=10⁻⁶ S/cm, and for example, insulating materials such as the aforementioned solid electrolyte material or resin may be included.

For example, the insulating material may be polyolefin such as polyethylene or polypropylene, polyester such as polyethylene terephthalate (PET), polyurethane, or polyimide.

In addition, the margin insulation layer 150 may include an inorganic solid electrolyte including an oxide-based solid electrolyte, a sulfide-based solid electrolyte, or a combination thereof used in the solid electrolyte layer 130. However, the material included in the margin insulation layer 150 is not limited thereto and may include various materials.

The positive electrode layer 120, the solid electrolyte layer 130, the negative electrode layer 140, and the margin insulation layer 150 may be stacked as described above to form a cell stack of the all-solid-state battery 100.

A protective layer made of an insulating material may be formed on the upper and lower ends of the cell stack of the all-solid-state battery 100.

In addition, terminals of the positive electrode current collector 123 and the negative electrode current collector 143 are exposed onto both sides of the cell stack of the all-solid-state battery 100, and the external electrodes 112 and 114 are connected to the exposed terminals and combined therewith. In other words, the external electrodes 112 and 114 are connected to the terminal of the positive electrode current collector 123 to form a positive electrode and also, connected to the terminal of the negative electrode current collector 143 to form a negative electrode. When the terminals of the positive electrode current collector 123 and the negative electrode current collector 143 are configured to face in opposite directions from each other, the external electrodes 112 and 114 may also be positioned at both sides, respectively.

The external electrodes 112 and 114 may include a conductive metal and glass.

The conductive metal may include, for example, copper (Cu), nickel (Ni), tin (Sn), palladium (Pd), platinum (Pt), gold (Au), silver (Ag), tungsten (W), titanium (Ti), lead (Pb), or an alloy thereof.

A glass component included in the first and second external electrodes 112 and 114 may have a composition in which an oxide is mixed. The glass component may include, for example, a silicon oxide, a boron oxide, an aluminum oxide, a transition metal oxide, an alkali metal oxide, an alkaline-earth metal oxide, or a combination thereof. Herein, the transition metal may be selected from zinc (Zn), titanium (Ti), copper (Cu), vanadium (V), manganese (Mn), iron (Fe), or nickel (Ni), the alkali metal may be selected from lithium (Li), sodium (Na), or potassium (K), and the alkaline-earth metal may be selected from magnesium (Mg), calcium (Ca), strontium (Sr), or barium (Ba).

A method of forming the first and second external electrodes 112 and 114 is not particularly limited. For example, the method may include dipping the cell stack in a conductive paste including a conductive metal and glass or screen-printing or gravure-printing the conductive paste on the surface of the cell stack. In addition, various methods of applying the conductive paste on the surface of the cell stack or transferring a dry film obtained by drying the conductive paste onto the cell stack may be used.

Hereinafter, specific examples of the invention are presented. However, the examples described below are only intended to specifically illustrate or explain the invention, and the scope of the invention should not be limited thereto.

### PREPARATION EXAMPLES

### Production Example 1: Preparation of Lithium Ion Conductor Cullet

Lithium oxide (Li₂O), boron oxide (B₂O), and silica (SiO₇) are used as raw materials to prepare lithium borosilicate glass. If necessary, phosphorus oxide (P₂O₅), germanium oxide (GeO₂), and the like as additional oxides in a total amount of about 5 mol % are added thereto.

The raw materials are homogeneously mixed, put in a platinum crucible, and melted at 900° C. to 1100° C. The molten glass liquid is rapidly quenched in an environment of a crystallization temperature or less, obtaining a colorless transparent cullet. The cullet is pulverized through coarse grinding and fine grinding processes, obtaining a frit. The frit has an average particle diameter of 1.0 μm to 10 μm, which may be adjusted, if needed.

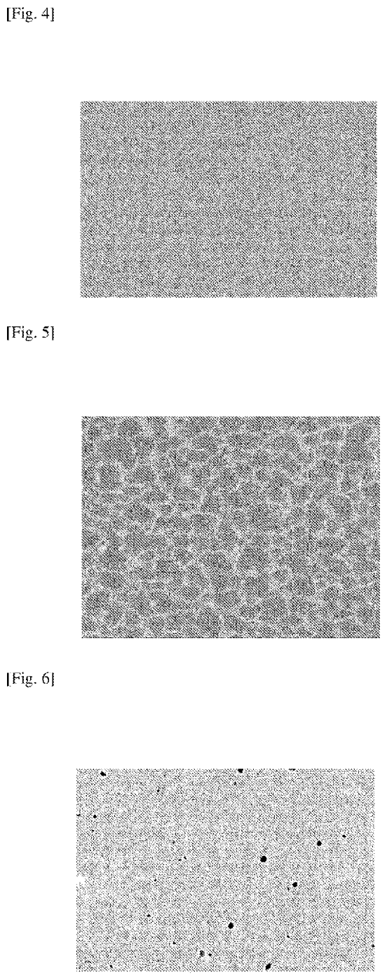

The prepared Li₂O—B₂O—SiO₂ amorphous lithium ion conductor cullet is taken of a ion milling cross-section scanning electron microscope (SEM) photograph, which is shown in FIG. 4.

### Preparation Example 2: Preparation of Lithium Ion Conductor Pellet

The prepared glass frits are processed into circle-shaped pellets for evaluation. Herein, baking is performed by using a pressurized baking equipment to reduce porosity. Herein, any pressure which may make the porosity into 1% or less within a range of 1 MPa to 200 MPa may be sufficient under any condition. A temperature may be set within an appropriate range through thermal analysis (Tg-DTA or DSC) depending on a glass composition. In order to prepare a lithium ion conductor having crystallinity of 25.5% or less, the baking is performed at a crystallization temperature or less. The crystallization temperature is determined by a ratio of the glass component and tends to be higher, as the higher the contents of Li₂O and B₂O₃, and the higher the content of SiO₂. However, the crystallization temperature may vary according to a type of the additional oxides. As shown in Tables 1 and 2 below, the lithium ion conductors of the examples and the comparative examples are prepared by adjusting the pressing conditions and the baking conditions.

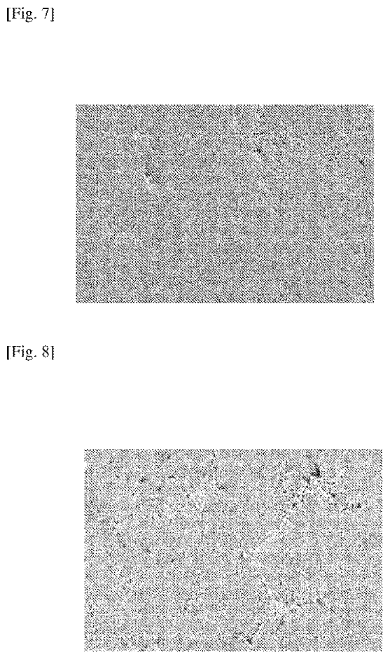

Ion milling cross-section scanning electron microscope (SEM) photographs of the lithium ion conductor pellets of Example 1 and Comparative Examples 1, 3, and 4 are respectively shown in FIGS. 5 to 8.

### EXPERIMENTAL EXAMPLES

### Experimental Example 1: Synthesis Evaluation of Lithium Ion Conductor

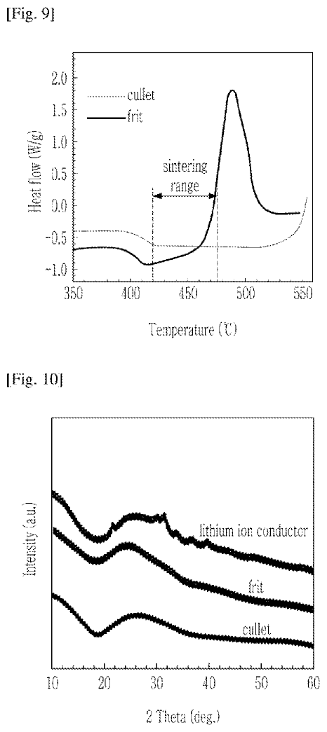

FIG. 9 shows thermal behavior results of a cullet and a frit containing 50 mol % of Li, O through the DSC analysis. Referring to FIG. 9, a lithium ion conductor is densified under a limited condition between Tg and Tx.

FIG. 10 is the results of the cullet, the frit, and the lithium ion conductor in a crystal state through the XRD analysis. Referring to FIG. 10, unlike the amorphous cullet and frit, the lithium ion conductor turns out to exhibit crystallinity of 25.5% or less.

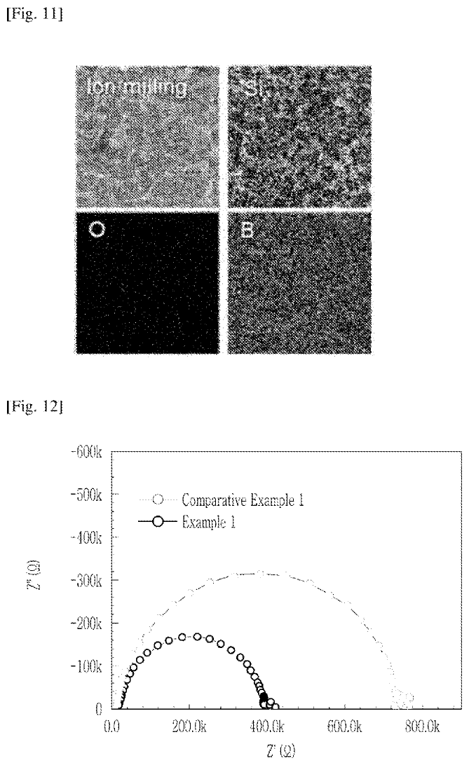

FIG. 11 is the SEM-EDAX mapping analysis result of the lithium ion conductor. Referring to FIG. 11, in the prepared lithium ion conductor, a seed has grown into crystals including Si, which matches the XRD result.

### Experimental Example 2: Electrochemical Characteristics Evaluation of Lithium Ion Conductor

The lithium ion conductors are evaluated with respect to lithium ion conductivity performance by conducting an electrochemical analysis.

FIG. 12 shows cole-cole plot results of the lithium ion conductors according to Example 1 and Comparative Example 1. Referring to FIG. 12, the lithium ion conductor of Example 1 exhibits excellent ion conductivity, compared with the lithium ion conductor of Comparative Example 1. In addition, the lithium ion conductor of Comparative Example 1 in which crystallization occurs exhibits twice increased resistance.

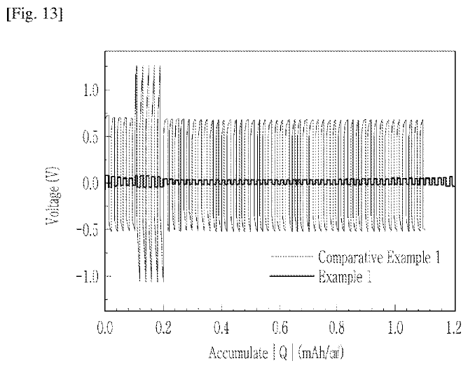

FIG. 13 is a voltage-capacity graph in symmetric cells of the lithium ion conductors according to Example 1 and Comparative Example 1. Referring to FIG. 13, the lithium ion conductor of Example 1 exhibits an overvoltage of 30 mV, when reacted from 10 μA·cm⁻² to 1 mAh·cm⁻² (200 h or higher), and thus secures electrochemical characteristics close to those of a liquid electrolyte. On the contrary, the lithium ion conductor of Comparative Example 1 exhibits overall deteriorated performance due to the crystallization.

### Experimental Example 3: Analysis of Characteristics of Lithium Ion Conductor

A platinum or gold element is coated on both surfaces of a lithium ion conductor pellet prepared at a high temperature under a high pressure and having 100 nm or higher of high transparency is formed. Herein, both of the surfaces must not be electrically connected. A cole-cole plot is obtained within a frequency range of c MHz to 0.01 Hz by using an electrochemical impedance analysis equipment, which is used to obtain ion conductivity by considering an area and a thickness of the lithium ion conductor, and the results are shown in Tables 1 and 2.

TABLE 1

| | | Firing | Firing | | | | |
|---|---|---|---|---|---|---|---|
| | | while | temperature | | Crystallinity | Porosity | Ion conductivity |
| | Composition | pressurizing | (° C.) | Crystal state | (%) | (%) | (S/cm) |
| Ex. 1 | Li₂O—B₂O₃—SiO₂ | Yes | 415 | amorphous | 0 | 0 | 2.33E−07 |
| Ex. 2 | Li₂O—B₂O₃—SiO₂ | Yes | 430 | amorphous + | 25.13 | 0 | 1.34E−07 |
| | | | | crystal | | | |
| Ex. 3 | Li₂O—B₂O₃—SiO₂—P₂O₅—GeO₂ | Yes | 475 | amorphous + | 14.27 | 0.1 | 1.67E−07 |
| | | | | crystal | | | |
| Comp. | Li₂O—B₂O₃—SiO₂ | Yes | 450 | crystal | 100 | 0.97 | 1.59E−08 |
| Ex. 1 | | | | | | | |

TABLE 2

| | | Firing | Firing | | | | Ion |
|---|---|---|---|---|---|---|---|
| | | while | temperature | | Crystallinity | Porosity | conductivity |
| | Composition | pressurizing | (° C.) | Crystal state | (%) | (%) | (S/cm) |
| Comp. | Li₂O—B₂O₃—SiO₂ | No | 450 | amorphous | 0 | 31.24 | 1.72E−09 |
| Ex. 2 | | | | | | | |
| Comp. | Li₂O—B₂O₃—SiO₂ | No | 460 | amorphous + | 27.23 | 3.26 | 2.63E−08 |
| Ex. 3 | | | | crystal | | | |
| Comp. | Li₂O—B₂O₃—SiO₂—P₂O₅—GeO₂ | No | 475 | amorphous + | 29.61 | 2.85 | 1.09E−08 |
| Ex. 4 | | | | crystal | | | |
| Comp. | Li₂O—B₂O₃—SiO₂—P₂O₅—GeO₂ | No | 500 | crystal | 100 | 4.68 | 1.42E−08 |
| Ex. 5 | | | | | | | |

Referring to Tables 1 and 2, a lithium ion conductor having crystallinity of 25.5% or less exhibits ion conductivity of 1.0×10⁷ S/cm or more.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### INDUSTRIAL APPLICABILITY

The present disclosure relates to a lithium ion conductor and an all-solid-state battery including the same, in which the lithium ion conductor is capable of freely adjusting ionic conductivity, minimizing an amount of decrease in ion conductivity in the process of manufacturing a stacked all-solid-state battery, and thus predicting ion conductivity in a stacked all-solid-state battery

### DESCRIPTION OF SYMBOLS

100: all-solid-state battery
112, 114: external electrode
120: positive electrode layer
121, 122: positive active material layer
123: positive electrode current collector
130: solid electrolyte layer
140: negative electrode layer
141, 142: negative electrode active material layer
143: negative electrode current collector
150: margin insulation layer

1. A lithium ion conductor for an all-solid-state battery, comprising
an oxide including lithium (Li), silicon (Si), and boron (B),
wherein the lithium ion conductor has a crystallinity less than or equal to 25.5%.

2. The lithium ion conductor for an all-solid-slate battery of claim 1, wherein the crystallinity is calculated by Equation 1:
Crystallinity (%)=[Ic/(Ic+Ia)]×100, [Equation 1]
wherein, in Equation 1, Ic is a sum of integrated values of scattering intensities of crystalline peaks in an X-ray diffraction analysis spectrum of the lithium ion conductor, and
Ia is a sum of integral values of scattering intensities of an amorphous halo in the X-ray diffraction analysis spectrum of the lithium ion conductor.

3. The lithium ion conductor for an all-solid-state battery of claim 1, wherein
the lithium ion conductor has the crystallinity of 0% to 12.5%.

4. The lithium ion conductor for an all-solid-state battery of claim 1, wherein
the lithium ion conductor has a porosity of less than or equal to 1%.

5. The lithium ion conductor for an all-solid-state battery of claim 4, wherein
the lithium ion conductor has the porosity of 0% to 0.5%.

6. The lithium ion conductor for an all-solid-state battery of claim 1, wherein
the lithium ion conductor comprises 45 mol % to 80 mol % of the lithium (Li) oxide, 5 mol % to 20 mol % of the silicon (Si) oxide, 15 mol % to 50 mol % of the boron (B) oxide based on a total amount of the lithium (Li) oxide, the silicon (Si) oxide, and the boron (B) oxide included in the lithium ion conductor.

7. The lithium ion conductor for an all-solid-state battery of claim 6, wherein
the lithium ion conductor comprises 50 mol % to 70 mol % of the lithium (Li) oxide based on the total amount of the lithium (Li) oxide, the silicon (Si) oxide, and the boron (B) oxide included in the lithium ion conductor.

8. The lithium ion conductor for an all-solid-state battery of claim 1, wherein
the lithium ion conductor comprises an additional oxide including Na (sodium), Mg (magnesium), Al (aluminum), P (phosphorus), K (potassium), Ca (calcium), Ti (titanium), V (vanadium), Cr (chromium), Mn (manganese), Fe (iron), Co (cobalt), Ni (nickel), Cu (copper), Zn (zinc), Ga (gallium), Ge (germanium), Se (selenium), Rb (rubidium), S (sulfur), Y (yttrium), Zr (zirconium), Nb (niobium), Mo (molybdenum), Ag (silver), In (indium), Sn (tin), Sb (antimony), Cs (cesium), Ba (barium), Hf (hafnium), Ta (tantalum), W (tungsten), Pb (lead), Bi (bismuth), Au (gold), La (lanthanum), Nd (neodymium), Eu (europium), or a combination thereof.

9. The lithium ion conductor for an all-solid-state battery of claim 1, wherein
the lithium ion conductor further comprises an additional oxide including P (phosphorus) and Ge (germanium).

10. The lithium ion conductor for an all-solid-state battery of claim 8, wherein
the lithium ion conductor comprises the additional oxide in an amount of less than or equal to 5 mol % based on a total amount of the lithium (Li) oxide, the silicon (Si) oxide, the boron (B) oxide, and the additional oxide included in the lithium ion conductor.

11. The lithium ion conductor for an all-solid-state battery of claim 10, wherein
the lithium ion conductor comprises the additional oxide in the amount of less than or equal to 1 mol % based on the total amount of the lithium (Li) oxide, the silicon (Si) oxide, the boron (B) oxide, and the additional oxide included in the lithium ion conductor.

12. A method for preparing a lithium ion conductor, comprising firing oxide powders including lithium (Li), silicon (Si), and boron (B) while pressurizing,
wherein the lithium ion conductor has a crystallinity less than or equal to 25.5%.

13. The method of claim 12, wherein the crystallinity is calculated by Equation 1:
Crystallinity (%)=[Ic/(Ic+Ia)]×100, [Equation 1]
wherein, in Equation 1, Ic is a sum of integrated values of scattering intensities of crystalline peaks in an X-ray diffraction analysis spectrum of the lithium ion conductor, and
Ia is a sum of integral values of scattering intensities of an amorphous halo in the X-ray diffraction analysis spectrum of the lithium ion conductor.

14. The method of claim 12, wherein
the firing is performed at a temperature of 300° C. to 550° C.

15. The method of claim 12, wherein
during the pressurizing, a pressure of 1 MPa to 200 MPa is applied.

16. An all-solid-state battery, comprising
a solid electrolyte layer and a positive electrode and a negative electrode disposed with the solid electrolyte layer therebetween, wherein one selected from the solid electrolyte layer, the positive electrode, the negative electrode, and a combination thereof comprises a lithium ion conductor including an oxide including lithium (Li), silicon (Si) and boron (B), and
the lithium ion conductor has a crystallinity less than or equal to 25.5%.

17. The all-solid-state battery of claim 16, wherein the crystallinity is calculated by Equation 1:
Crystallinity (%)=[Ic/(Ic+Ia)]×100, [Equation 1]
wherein, in Equation 1, Ic is a sum of integrated values of scattering intensities of crystalline peaks in an X-ray diffraction analysis spectrum of the lithium ion conductor, and
Ia is a sum of integral values of scattering intensities of an amorphous halo in the X-ray diffraction analysis spectrum of the lithium ion conductor.

18. The all-solid-state battery of claim 16, wherein
the lithium ion conductor has a porosity of less than or equal to 1%.

19. The all-solid-state battery of claim 16, wherein
the lithium ion conductor comprises 45 mol % to 80 mol % of the lithium (Li) oxide, 5 mol % to 20 mol % of the silicon (Si) oxide, 15 mol % to 50 mol % of the boron (B) oxide based on a total amount of the lithium (Li) oxide, the silicon (Si) oxide, and the boron (B) oxide included in the lithium ion conductor.

20. The all-solid-state battery of claim 16, wherein
the lithium ion conductor further comprises an additional oxide including Na (sodium), Mg (magnesium), Al (aluminum), P (phosphorus), K (potassium), Ca (calcium), Ti (titanium), V (vanadium), Cr (chromium), Mn (manganese), Fe (iron), Co (cobalt), Ni (nickel), Cu (copper), Zn (zinc), Ga (gallium), Ge (germanium), Se (selenium), Rb (rubidium), S (sulfur), Y (yttrium), Zr (zirconium), Nb (niobium), Mo (molybdenum), Ag (silver), In (indium), Sn (tin), Sb (antimony), Cs (cesium), Ba (barium), Hf (hafnium), Ta (tantalum), W (tungsten), Pb (lead), Bi (bismuth), Au (gold), La (lanthanum), Nd (neodymium), Eu (europium), or a combination thereof.

21. The all-solid-state battery of claim 16, wherein
the all-solid-state battery comprises a stack including a plurality of solid electrolyte layers and a plurality of positive electrodes and negative electrodes alternately disposed with the plurality of solid electrolyte layers therebetween, and first and second external electrodes on one side and the other side opposite to the one side of the stack and connected to the positive electrodes and the negative electrodes, respectively.
